(19) United States
(12) Patent Application Publication
(10) Pub. No.: US 2015/0091289 A1
(43) Pub. Date: Apr. 2, 2015

(54) UNITARY SPECIAL SERVICE DELIVERY FORM MAILPIECE FOR DELIVERY VIA A SPECIAL SERVICE AND METHOD OF USING SAME

(71) Applicant: USA Images of Florida, L.L.C., Vero Beach, FL (US)

(72) Inventors: Glenn Petkovsek, Vero Beach, FL (US); Robert Bluejacket, Cabot, AR (US)

(73) Assignee: USA IMAGES OF FLORIDA, L.L.C., Vero Beach, FL (US)

(21) Appl. No.: 14/042,243

(22) Filed: Sep. 30, 2013

(51) Int. Cl. B42D 15/00; B65D 27/00

(52) U.S. Cl. CPC B42D 15/00; B65D 27/00
USPC 283/67; 283/116

(57) ABSTRACT

A unitary special service form mailpiece for delivery via a special service has a pocket for holding and/or mailing documents, envelopes, forms, checks and/or the like via the special service. A top panel with a receipt and a label section is removably attached to a bottom panel. The label has information related to the delivery of the article by the special service. An electronic return receipt information section and a special services designation section are located on the mailpiece. The mailpiece is prepared for delivery by printing information on the form necessary to comply with the special service delivery requirements and electronic return receipt of the mailpiece. The information has a machine-readable code section with machine-readable information associated with the mailpiece. The bottom panel of the mailpiece has an integrally formed envelope that is removed before folding, assembling and sealing the mailpiece.

### BACKGROUND OF THE INVENTION

The present invention generally relates to a mailpiece for delivery via a special service. More specifically, the present invention relates to a unitary special service delivery form mailpiece for delivery by a special service having an electronic return receipt and a method for using same. The special service may be, for example, priority mail, certified mail, critical mail and/or the like.

It is generally known to mail items requiring special services for delivery of the item, such as certified mail, registered mail, priority mail, first class mail, critical mail, insured mail, cash on delivery (“COD”), return receipt for merchandise and/or the like. For example, the U.S. Postal Service (“USPS”) provides certified mail service and registered mail service for priority mail and for first class mail. For certified mail, the USPS may provide both proof of deposit, proof of delivery, and/or online tracking using a tracking number or a unique article ID. For certified mail, the USPS may obtain a signature of the recipient at the time of delivery which the USPS electronically stores in USPS records and/or which may be retrieved by the sender. Registered mail may be used for highly valuable and/or irreplaceable items. Registered mail may include tracking services. Critical mail service may provide proof of deposit, proof of delivery, recipient signature confirmation and/or online tracking using the tracking number and/or the unique article ID.

Known components and/or methods for assembling a mailpiece for mailing items requiring special services may have multiple, separate components requiring attachment to an exterior of an envelope for the special services delivery of the item. For example, the special services designation section has been implemented as a separate and/or distinct form from a return postcard, for example, USPS Form 3811. The present invention may allow for incorporation of what previously required completion of two forms and subsequent attachment of the two forms to, for example, a mailpiece to be delivered requiring special services for delivery.

A postal employee typically may receive an envelope from a customer for mailing the item via the special service. The postal employee then may require the customer to attach or otherwise provide the envelope with a permanent seal or label indicating that the envelope requires delivery and/or tracking by the special service. The postal employee must ensure that all appropriate labels and/or documents are both stocked and/or available for use and are completed and/or affixed to the envelope prior to delivery of the article. Such a procedure may be complex, time-consuming and/or labor-intensive. Further, the procedure may be confusing to the customer mailing the item.

Further, the postal employee must ensure that all labels and/or the return receipt postcard must be suitably affixed to the envelope so that the return postcard is not removed during the mailing of the article to its destination. Of course, it should be understood that an envelope prepared for special service mailing may be prepared by any individual, not just a postal employee.

Further, the existing special service mailpieces and methods may be time-consuming for customers who are mailing mass quantities of mailpieces via special services with return receipts. Thus, a need exists for a simplified, unitary special service delivery form mailpiece for delivery by a special service and a method for using same.

To eliminate some of the problems with typical mailing systems and/or processes, a mail customer may utilize an electronic return receipt (“ERR”) service available from the USPS. Users of such a service may obtain their return receipts in bulk rather than by individual requests. This service meets at least three customer needs. First, the electronic return receipt service may save time and/or free the mail owner from having to request individual proof of delivery records and/or from placing PS Form 3811, Domestic Return Receipt, on each mailpiece. Second, users of the electronic return receipt service may retain signature records for longer than the standard retention period of the USPS. Third, the electronic return receipt service may provide users with a more efficient way to handle signature records. Also, users may receive mailpiece recipient signatures in bulk by participating in the Bulk Proof of Delivery (“BPOD”) program offered by the USPS. BPOD allows participants using privately printed certified mail, insured mail, or registered mail bar-coded labels to add return receipt service and/or receive those return receipts electronically in bulk. With this scenario, when a USPS employee delivers a signature-service mailpiece, the recipient signs his or her name on PS Form 3849, Delivery Notice/Reminder/Receipt. The USPS employee may scan customer information on the form, and the customer information may then be linked to the delivery event for the mailpiece. Typically, the process may be completed within twenty-four hours.

Of course, it should be understood that a mailpiece being prepared for mailing by special services may be prepared by any individual, not just a postal employee. Additionally, the mailpiece may be prepared by the individual in advance of the time of deposit with the postal carrier. Preparing a mailpiece for mailing by special services prior to deposit with the postal employee may save time for both the customer and/or the postal employee.

A need, therefore, exists for a unitary special service mailing form mailpiece for mailing an item requiring delivery by a special service such as certified mail, insured mail, registered mail, COD, return receipt for merchandise and/or the like having an electronic return receipt and a label indicative of the special service and a method for using same.

Further, a need exists for a unitary special service delivery form mailpiece for delivery by a special service having an electronic return receipt and a method for using same that may allow a customer to print communications, marketing information, addresses, postage and/or the like directly on the mailpiece prior to assembly, sealing and deposit with the postal carrier.

A need also exists for a unitary special service delivery form mailpiece for delivery by a special service having an electronic return receipt and a method for using same that may have a pocket that may be used, if needed, to mail item(s), such as, for example, papers, documents, checks, forms and/or the like via the special service.

A further need exists for a unitary special service delivery form mailpiece for delivery by a special service having an electronic return receipt and a method for using same that may be permanently sealed prior to mailing via the special service.

Still further, a need exists for a unitary special service delivery form mailpiece for delivery by a special service having an electronic return receipt and a method for using same that may be intuitive and/or easy to use by a customer requiring a special services mailing assembly.

Moreover, a need exists for a unitary special service delivery form mailpiece for delivery by a special service having an electronic return receipt and a method for using same that may not require special equipment, such as, for example, a folder, a sealer and/or the like to prepare the mailpiece for mailing.

Further, a need exists for a unitary special service delivery form mailpiece for delivery by a special service having an electronic return receipt and a method for using same that may be assembled for mailing at, for example, one desk or one workstation.

Yet further, a need exists for a unitary special service delivery form mailpiece for delivery by a special service having an electronic return receipt and a method for using same that may be intuitive and/or easy to open by a recipient.

### SUMMARY OF THE INVENTION

The present invention generally relates to a mailpiece for delivery via a special service. More specifically, the present invention relates to a unitary special service delivery form mailpiece for delivery by a special service having an electronic return receipt and a method for using same. The special service may be, for example, priority mail, certified mail, critical mail and/or the like. The mailpiece may have a pocket for holding documents, envelopes, forms, checks, tickets and/or the like.

To this end, in an embodiment of the present invention, a unitary special service form mailpiece for delivery via a special service is provided. The mailpiece may have a generally rectangular sheet having a width defined between a front side and a rear side, a height defined between a top end and a bottom end and a length defined between a first end and a second end. The sheet may be divided into a top panel and a bottom panel. A separation line that extends between the first end of the sheet and the second end of the sheet may separate the top panel and the bottom panel. The top panel may be removable from the bottom panel at the separation line. The bottom panel may have a fold line that extends between the first end of the sheet and the second end of the sheet. The mailpiece may also have a flap defined between the separation line and the fold line. The flap may extend between the first end of the sheet and the second end of the sheet. The flap may have a front side and a rear side. The bottom panel may have a pocket extending between the first end and the second end. The pocket may also extend between the bottom end and the fold line. The pocket may have an opening adjacent to the fold line. The mailpiece may have an adhesive on the rear side of the flap that may adhere the flap to the rear side of the bottom panel when the flap is folded along the fold line. The flap may thereby seal the opening of the pocket. Further, the mailpiece may have a first section on the front side of the mailpiece. The first section may have information related to an electronic return receipt service associated with the mailpiece. The first section may have a machine-readable code section with machine-readable information associated with the mailpiece. The mailpiece may also have a second section on the front side of the mailpiece. The second section may have information indicative of the special service for delivery of the mailpiece.

In an embodiment, the separation line may be a linear perforation.

In an embodiment, the mailpiece may have an auxiliary special services designator section on the top panel. The auxiliary special services designator section may have information indicative of the special service and also may be separable from the bottom panel via the separation line.

In an embodiment, the mailpiece may have a receipt on the top panel. The receipt may have information associated with the delivery of the mailpiece by the special service and may be separable from the bottom panel via the separation line.

In an embodiment, the mailpiece may have an auxiliary information section printed on the sheet. The auxiliary information section may have information unrelated to the mailpiece.

In an embodiment, the mailpiece may have a Quick Response (QR) code printed on the sheet. The QR code may have machine-readable information.

In an embodiment, the mailpiece may have instructions for use of the mailpiece printed on the sheet.

In an embodiment, the mailpiece may have a message section located on the rear side of the mailpiece. A communication may be printed on the message section.

In an embodiment, the sheet may be a laminated paper product.

In an embodiment, the mailpiece may have an adhesive label on the top panel. The adhesive label may be removable from the top panel.

In another embodiment of the invention, a method for preparing a mailpiece for delivery by a special service is provided. The method may have the steps of providing a unitary special services form mailpiece wherein the mailpiece may have a pocket; printing information on the mailpiece wherein the information may be necessary to comply with requirements for the delivery of the mailpiece by the special service; printing information on the mailpiece wherein the information may be related to delivery of the mailpiece; and printing information on the mailpiece wherein the information may be necessary to comply with requirements for electronic return receipt of the mailpiece. The information may have a machine-readable code section with machine-readable information concerning electronic return receipt of the mailpiece associated with the mailpiece.

In an embodiment, the method may have the steps of inserting an item into the pocket and sealing the pocket to enclose the item within the pocket before mailing the mailpiece.

In an embodiment, the method may have the steps of printing a label on the mailpiece and removing the label from the mailpiece before mailing the mailpiece. The label may have information related to the special service of the mailpiece.

In an embodiment, the method may have the steps of printing a receipt on the mailpiece and removing the receipt from the mailpiece before mailing the mailpiece. The receipt may have information related to the delivery of the mailpiece.

In an embodiment, the method may have the step of printing auxiliary information on the sheet. The auxiliary information may have information unrelated to the mailpiece.

In an embodiment, the method may have the step of printing a communication on the rear side of the mailpiece.

In a further embodiment of the invention, a method for preparing a mailpiece for delivery by a special service using a mailing application on a computer system is provided. The method may have the steps of accessing the mailing application on the computer system; creating a mail file using the mailing application wherein the mail file may have information associated with delivery and the special service for the mailpiece; processing the mail file information using the mailing application to produce an image containing information required by an entity to deliver the mailpiece by the special service; and printing the image onto the mailpiece.

In an embodiment, the method may have the steps of transferring the mail file to the entity using the mailing application and receiving tracking information from the entity.

In an embodiment, the method may have the step of receiving electronic return receipt information from the entity.

In an embodiment, the method may have the step of storing electronic return receipt information from the entity in a database using the mailing application.

It is, therefore, an advantage of the present invention to provide a unitary special service delivery form mailpiece for delivery by a special service having an electronic return receipt and a method for using same. The special service may be, for example, priority mail, certified mail, critical mail and/or the like.

A further advantage of the present invention is to provide a unitary special service delivery form mailpiece for delivery by a special service having an electronic return receipt and a method for using same that may provide space for printing a communication thereon prior to folding, assembling and/or sealing the mailpiece for deposit with a postal carrier and/or a delivery person.

Yet another advantage of the present invention is to provide a unitary special service delivery form mailpiece for delivery by a special service having an electronic return receipt and a method for using same wherein the interior portion of the mailpiece may have a pocket that may be used for holding and/or mailing documents, envelopes, forms, checks, tickets and/or the like via the special service.

Moreover, an advantage of the present invention is to provide a unitary special service delivery form mailpiece for delivery by a special service having an electronic return receipt and a method for using same that may be sealed prior to mailing via the special service.

Another advantage of the present invention is to provide a unitary special service delivery form mailpiece for delivery by a special service having an electronic return receipt and a method for using same that may be intuitive and easy to use by a customer requiring a special services mailing assembly or special equipment.

Yet another advantage of the present invention is to provide a unitary special service delivery form mailpiece for delivery by a special service having an electronic return receipt and a method for using same that may be intuitive and/or easy to open by a recipient.

Another advantage of the present invention is to provide a unitary special service delivery form mailpiece for delivery by a special service having an electronic return receipt and a method for using same that may have a detachable portion.

Yet another advantage of the present invention is to provide a unitary special service delivery form mailpiece for delivery by a special service having an electronic return receipt and a method for using same wherein a detachable portion may have removable adhesive labels, such as, for example, an addressee label, a return address label, a special service label, a unique article number label, a bar code label, a tracking number label, a postage label, a receipt and/or the like to effect and/or to track delivery via the special service.

A still further advantage of the present invention is to provide a unitary special service delivery form mailpiece for delivery by a special service having an electronic return receipt and a method for using same that may be customized prior to mailing using simplex and/or duplex printing methods.

Another advantage of the present invention is to provide a unitary special service delivery form mailpiece for delivery by a special service having an electronic return receipt and a method for using same wherein information, such as, for example, a delivery address, a return address, a special services tracking number, a special service bar code, postage and/or the like may be printed on the mailpiece before and/or after final assembly for deposit with the postal carrier and/or delivery person.

Another advantage of the present invention is to provide a simplified method for mailing a mailpiece requiring special services.

A further advantage of the present invention is to provide a unitary special service delivery form mailpiece for delivery by a special service having an electronic return receipt and a method for using same that is integrally formed as a complete unit for mailing and labeling of a mailpiece requiring special services.

Yet another advantage of the present invention is to provide a unitary special service delivery form mailpiece for delivery by a special service having an electronic return receipt and a method for using same without requiring additional adhesives or fixatives for attaching the same to the mailpiece.

Moreover, an advantage of the present invention is to provide a unitary special service delivery form mailpiece for delivery by a special service having an electronic return receipt and a method for using same that is substantially foolproof.

Yet, a further advantage of the present invention is to provide a unitary special service delivery form mailpiece for delivery by a special service having an electronic return receipt and a method for using same that works on automated printing equipment.

Another advantage of the present invention is to provide a unitary special service delivery form mailpiece for delivery by a special service having an electronic return receipt and a method for using same that provides for pre-imaging or pre-printing of variable information thereon.

An advantage of the present invention is to provide a unitary special service delivery form mailpiece for delivery by a special service having an electronic return receipt and a method for using same that uses an electronic return receipt.

Yet another advantage of the present invention is to provide a unitary special service delivery form mailpiece for delivery by a special service having an electronic return receipt and a method for using same without requiring that any additional forms be attached to the mailpiece.

Another advantage of the present invention is to provide a unitary special service delivery form mailpiece for delivery by a special service having an electronic return receipt and a method for using same that may be intuitive and/or easy to use by a customer requiring a special services mailing assembly or special equipment.

A further advantage of the present invention is to provide a unitary special service delivery form mailpiece for delivery by a special service having an electronic return receipt and a method for using same wherein a removable label section is provided on the mailpiece.

Yet another advantage of the present invention is to provide a unitary special service delivery form mailpiece for delivery by a special service having an electronic return receipt and a method for using same wherein the special services designation section is variably printed with a machine readable code.

A further advantage of the present invention is to provide a unitary special service delivery form mailpiece for delivery by a special service having an electronic return receipt and a method for using same wherein an area within the special services designation section may have a machine readable code.

Another advantage of the present invention is to provide a unitary special service delivery form mailpiece for delivery by a special service having an electronic return receipt and a method for using same wherein the special services designation section is distinctly colored.

Additional features and/or advantages of the present invention are described in, and will be apparent from, the detailed description of the presently preferred embodiments and/or from the drawings.

### BRIEF DESCRIPTION OF THE DRAWINGS

FIG. 1 illustrates a front plan view of a unitary special service delivery form mailpiece in an embodiment of the present invention.

FIG. 2 illustrates a rear plan view of a unitary special service delivery form mailpiece in an embodiment of the present invention.

FIG. 3 illustrates a front plan view of a unitary special service delivery form mailpiece in an embodiment of the present invention.

FIG. 4 illustrates a front plan view of a detachable portion of a unitary special service delivery form mailpiece in an embodiment of the present invention.

FIG. 5 illustrates a rear plan view of a detachable portion of a unitary special service delivery form mailpiece in an embodiment of the present invention.

FIG. 6 illustrates a rear plan view of a unitary special service delivery form mailpiece in an embodiment of the present invention.

FIG. 7 illustrates a front perspective view of a unitary special service delivery form mailpiece in an embodiment of the present invention.

FIG. 8 illustrates a cross-sectional view taken along line VIII-VIII of FIG. 7 of a unitary special service delivery form mailpiece in an embodiment of the present invention.

FIG. 9 illustrates a rear plan view of an envelope of a unitary special service delivery form mailpiece for mailing via a special service in an embodiment of the present invention.

FIG. 10 illustrates a front plan view of an envelope of a unitary special service delivery form mailpiece for mailing via a special service in an embodiment of the present invention.

FIG. 11 illustrates a block diagram of an embodiment of a computer system for use with the present invention.

FIG. 12 illustrates a flowchart of an embodiment of a method of the present invention.

### DETAILED DESCRIPTION OF THE PRESENTLY PREFERRED EMBODIMENTS

The present invention generally relates to a mailpiece for delivery via a special service. More specifically, the present invention relates to a unitary special service delivery form mailpiece for delivery by a special service having an electronic return receipt and a method for using same.

The present invention may be manufactured to meet the U.S. Postal Service standards for the special service selected by the sender, including, but not limited to, certified mail, registered mail, priority mail, first class mail, critical mail, insured mail, COD, return receipt for merchandise and/or the like. Further, the present invention may be utilized by other delivery-type services. The present invention should not be deemed as limited to a specific special service, postal service and/or delivery service. It should be understood that the special service may be any special service provided by a postal carrier, delivery carrier and/or a parcel carrier as known to one having ordinary skill in the art.

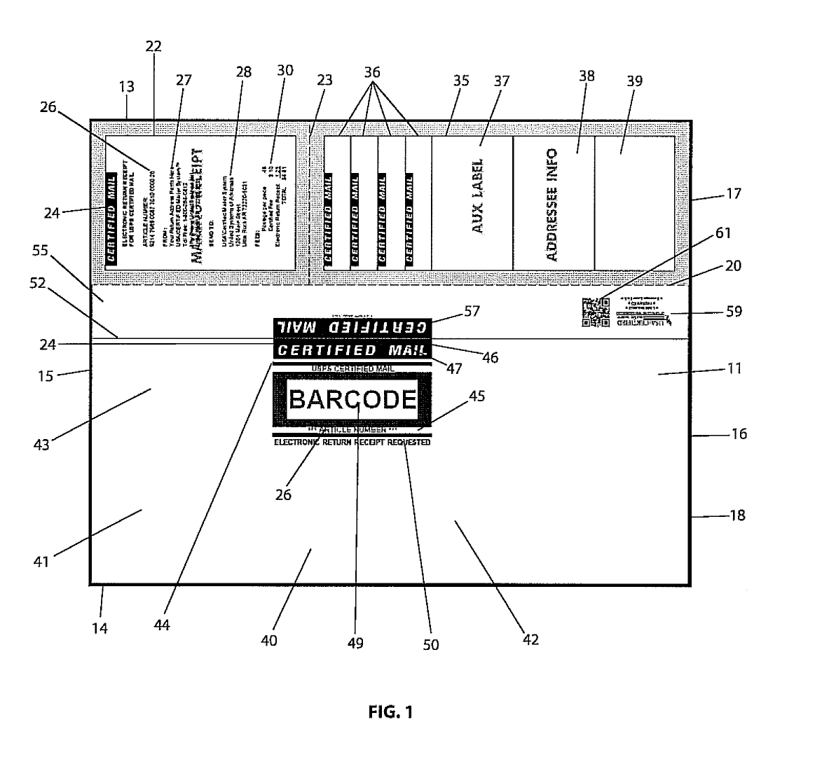

Referring now to the drawings wherein like numerals refer to like parts, FIG. 1 illustrates a front plan view of a unitary special service delivery form mailpiece 10 (“mailpiece 10”) in an embodiment of the present invention. FIG. 2 illustrates a rear plan view of the mailpiece 10 in an embodiment of the present invention. As shown in FIGS. 1 and 2, the mailpiece 10 may be generally rectangular in shape. The mailpiece 10 may have a front side 11 shown in FIG. 1 and a rear side 12 shown in FIG. 2. The rear side 12 may be positioned opposite to the front side 11. The mailpiece 10 may have a height defined between a top end 13 and a bottom end 14 that may be positioned opposite to the top end 13. The mailpiece 10 may have a length defined between a first end 15 and a second end 16 that may be positioned opposite to the first end 15.

Further, FIG. 1 illustrates the mailpiece 10 in a “blank” state, i.e., without any printing related to the addressee of the mailpiece 10. Although the mailpiece 10 may be considered to be in a “blank” state, the mailpiece 10 may have some printing on the mailpiece 10. For example, the mailpiece 10 shown in FIG. 1 may be printed for using a special service such as certified mail. However, no addressee information is shown on the mailpiece 10 as required to deliver the mailpiece 10. The mailpiece 10 may be provided for use in a “blank” state and/or a printed state in which the address of the intended recipient may be printed on the mailpiece 10.

Thus, the mailpiece 10 may be provided without the necessary information required for delivery of the mailpiece 10 by a special service. Thus, the mailpiece 10 may be provided as a “blank” mailing assembly. The mailpiece 10 may then be fed into a printing device whereupon the necessary information for delivery by the special service may be printed on the desired areas of the mailpiece 10.

Moreover, the mailpiece 10 may be printed using any known method of printing and may not be limited to any single type. Such printing methods may include, but are not limited to, laser printing, thermal printing, dot matrix printing and/or the like. Printing may be performed on continuously fed forms and/or on individually fed forms.

Thus, the mailpiece 10 may be provided as a “blank” whereupon variable information may be printed. The variable information may include information relating to the special service and/or any other information required and/or desired to effect the delivery of the mailpiece requiring delivery by the special services. Each mailpiece may be printed with the same information, for example, for sending multiple mailpieces 10 to the same address. Also, each mailpiece 10 may be individually printed with unique information for separate mailings to different addressees and/or for sending the same mailpiece 10 to different addressees.

The mailpiece 10 may be used for mailing an item requiring a special service. Although the mailpiece 10 illustrated in the figures may be for use with certified mail, it should be understood that the present invention may be applicable to any item requiring any one or more special services, such as insured mail, registered mail, COD, return receipt for merchandise and/or the like.

In the embodiment shown in FIGS. 1 and 2, the mailpiece 10 may have components and/or sections. For example, the mailpiece 10 may be divided into a top panel 17 and a bottom panel 18 by a first separation line 20, such as, for example, a linear perforation, a score line, one or more slits, one or more slots, a partial or incomplete tear and/or the like. The first separation line 20 may extend from the first end 15 to the second end 16. Thus, the top panel 17 may be detachable from the bottom panel 18 via the first separation line 20.

As shown in FIGS. 1, 2, 4 and 5, the top panel 17 may also be sub-divided into several sections and/or components. For example, the top panel 17 may have a receipt section 22. The receipt section 22 may be detachable and/or separable from the bottom panel 18. The receipt section 22 may have information relevant to the shipment. For example, such information may have, but may not be limited to, a special service indicator 24 of the type of special service. For example, the special service indicator 24 may denote “CERTIFIED MAIL” as the type of special service. A unique article identification number 26 may also be included on the receipt section 22. Further, a sender address 27 and/or a recipient address 28 may be included on the receipt section 22. Also, a fee summary 30 itemizing the fees associated with the special service and/or the postage may be provided on the receipt section 22.

In an embodiment, the top panel 17 may also have a label section 35. The label section 35 may be detachable and/or separable from the bottom panel 18. Also, the receipt section 22 may be detachable and/or separable from the label section 35 via a second separation line 23, such as, for example, a linear perforation, a score line, one or more slits, one or more slots, a partial or incomplete tear and/or the like. The second separation line 23 may extend generally perpendicularly from the first separation line 20 to the top end 13 of the top panel 17 of the mailpiece 10. Thus, the receipt section 22 may be detachable from the label section 35 of the top panel 17 via the second separation line 23. Further, the receipt section 22 may be detachable from the bottom panel 18 via the first separation line 20. Thus, the components of the top panel 17, i.e., the label section 35 and/or the receipt section 22, may be separated from the bottom panel 18. Also, the receipt section 22 and/or the label section 35 may each be individually separated from each other and/or from the bottom panel 18.

The label section 35 may have special service indicator labels 36. The embodiment shown in FIG. 1 illustrates four special service indicator labels 36. The label section 35 may also have an auxiliary label 37. The auxiliary label 37 may be variably printed with information desired by the user of the mailpiece 10. The information may be unique to the mailpiece 10. The information may be the same information for a number of mailpieces 10. Also, an addressee information label 38 may be provided in the label section 35. The addressee information label 38 may have the recipient address 28 or other information related to the recipient printed thereon. Finally, the label section 35 may have a miscellaneous section label 39. The miscellaneous section label 39 may be printed with any information that the user may desire and/or require.

As shown in FIGS. 1, 2, 3 and 7, the bottom panel 18 may also be sub-divided into several sections and/or components. For example, the bottom panel 18 may have an envelope 40. The envelope 40 may be separated from the other sections and/or components of the mailpiece 10 as the primary section used in the delivery process. The envelope 40 may have a front side 41 as shown in FIG. 1. The front side 41 of the envelope 40 may be pre-printed and/or manually printed, as desired by the user. The envelope 40 may also have several sections. For example, the envelope 40 may have an addressee section 42. The addressee section 42 may be pre-printed with the address of the intended recipient of the mailpiece 10. The envelope 40 may also have a return address section 43. The return address section 43 may be pre-printed with the address of the sender of the mailpiece 10.

Further, the envelope 40 may have a special services designation section 44 that may have information indicative of the special service on the envelope 40. The envelope 40 may be, in a preferred embodiment, pre-printed with the special services designation section 44 indicative of the special service required for mailing of the mailpiece 10.

Depending on the special service desired, the special services designation section 44 may have information necessary to comply with requirements for, for example, USPS Forms 3800, 3804, 3806, 3813, 3856 or the like. The special services designation section 44 may have the special service indicator 24 and a window section 45 in which the article identification number 26 may be printed. As shown in FIGS. 1 and 2, the special service indicator 24 may denote “CERTIFIED MAIL” as the type of special service used. However, any special services may be indicated, such as insured mail, registered mail, COD, return receipt for merchandise and/or the like.

The special services designation section 44 may also have a first area 46 that may be distinctly colored from a remainder of the area. For example, the color of the first area 46 may be green to designate the generally recognized color for certified mail or may be brown to designate the generally recognized color for return receipt for merchandise, or the like. Within the first area 46, a wording area 47 may be provided to specifically denote the type of special service for which the mailing may be implemented. As shown in FIGS. 1 and 2, the wording area 47 may contain the wording “CERTIFIED MAIL.” The article identification number 26 provided within the special services designation section 44 may be a machine-readable number associated with the mailpiece 10. The machine-readable number of the article identification number 26 may be used for tracking of the mailpiece 10 before, during and/or after delivery by the special service.

Further, a bar code 49 may be provided in the special services designation section 44. The bar code 49 may also be used for tracking of the mailpiece 10 before, during and/or after delivery by the special service. The special services designation section 44 may have, for example, the special service indicator 24, the unique article identification number 26 and/or the bar code 49 pre-printed on the front side 13 of the envelope 40. The special services designation section 44 may be associated with the special service selected by the sender. Although references may be made to the USPS, the mailpiece 10 of the present invention may be used with any other postal/parcel carriers that the user may select.

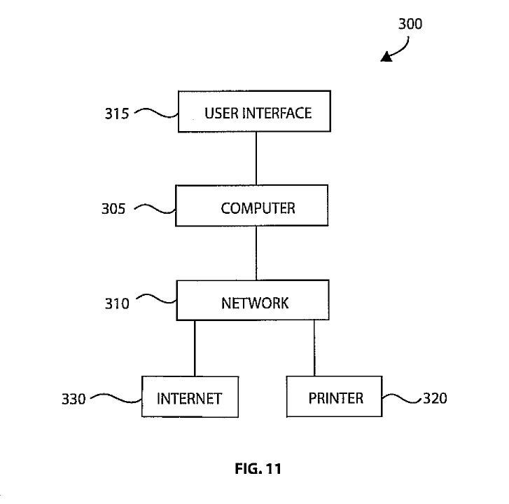

The postal/parcel carrier may scan or input the article identification number 26 and/or the barcode 49 into a computer system 300 as shown in FIG. 11 for tracking purposes. If the sender has not applied postage to the mailpiece 10, the postal/parcel carrier may sell postage to the sender and/or may apply postage to the mailpiece 10. The postal/parcel carrier may input the special service selected into the computer system 300 and/or may provide the sender with a receipt of deposit. The receipt may be used by the sender to track the delivery of the mailpiece 10 via the special service.

In an embodiment, the article identification number 26, the tracking number and/or the bar code 49 may be printed on the mailpiece 10 and/or may be retained as a receipt by the sender. The postal/parcel carrier may input and/or scan the article identification number 26 and/or the bar code 49 into the computer system 300 upon delivery to the recipient of the mailpiece. The sender may refer to the article identification number 26 and/or the bar code 49 to track the mailpiece during and/or after delivery by the special service using, for example, a computer interface, a telephone interface and/or a website provided for the special service by the postal/parcel carrier.

To further simplify the preparation of the mailpiece 10 requiring delivery by a special service, the envelope 40 may also have an electronic return receipt (“ERR”) information section 50 on the front side 41 of the envelope 40 for use with the ERR service provided by the USPS. The electronic return receipt information section 50 may have the wording “ELECTRONIC RETURN RECEIPT REQUESTED.” Use of the ERR service may satisfy at least three customer needs. First, the electronic return receipt service may save time and/or free the mail owner from having to request individual proof of delivery records and/or from placing PS Form 3811, Domestic Return Receipt, on each mailpiece. Second, users of the ERR service may retain signature records for longer than the standard retention period of the USPS. Third, the ERR service may provide users with a more efficient way to handle signature records.

Also, users may receive mailpiece recipient signatures in bulk by participating in the Bulk Proof of Delivery (“BPOD”) program offered by the USPS. BPOD allows participants using privately printed certified mail, insured mail, or registered mail bar-coded labels to add return receipt service and/or receive those return receipts electronically in bulk. With this scenario, when a USPS employee delivers a signature-service mailpiece, the recipient signs his or her name on PS Form 3849, Delivery Notice/Reminder/Receipt. The USPS employee may scan customer information on the form, and the customer information may then be linked to the delivery event for the mailpiece 10. Typically, the process may be completed within twenty-four hours. Thus, the electronic return receipt information section 50 may simplify the preparation and/or mailing process for the user, the USPS and/or the recipient of the mailpiece 10.

Referring to FIG. 1, the envelope 40 may also have a fold line 52. The fold line 52 may extend from the first end 15 to the second end 16. The envelope 40 may also have a flap 55 adjacent to the fold line 52. The flap 55 may also extend the length of the mailpiece 10 from the first end 15 to the second end 16. The flap 55 may extend from the fold line 52 to the first separation line 20. Thus, the flap 55 may be generally rectangular in shape. However, the flap 55 may be configured in other shapes without departing from the scope of the invention.

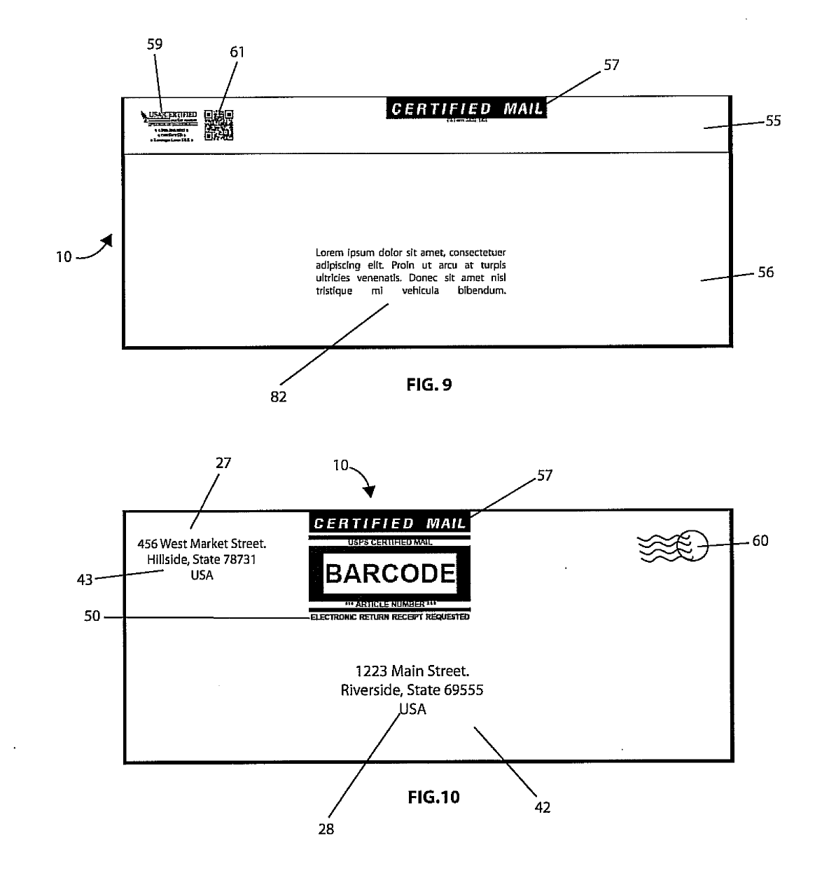

As also illustrated, the special services designation section may have an additional special service indicator 57 printed thereon. In an embodiment, the additional special service indicator 57 and/or the special service indicator 24 may be printed in such a way that they are inverted versions of each other. Thus, the special service indicator 24 on the special services designation section 44 may be located on the front side 41 of the envelope 40. The additional special service indicator 57 may then be folded over the fold line 52 of the envelope 40 and onto the flap 55 of the envelope 40. In this manner, the special services desired may be visible from the front side 41 of the envelope 40 and/or from a back side 56 of the envelope 40. As shown in FIG. 10, postage 60 may also be applied to the front side 41 of the envelope 40. The postage 60 may be an ink stamp, an automated printed image indicative of the correct postage and/or a postage stamp.

Moreover, the envelope 40 of the mailpiece 10 may have an auxiliary information section 59. The auxiliary information section 59 may have any information that may be related to the mailpiece 10 and/or the special services delivery of the mailpiece 10. Also, the auxiliary information section 59 may have information unrelated to the particular mailpiece but related to the shipment and/or preparation of the mailpiece. For example, a Quick Response code (“QR code”) 61 may be provided. The QR code 61 may connect the user with the contact information and/or the website of the manufacturer of the mailpiece 10 to facilitate the shipment and/or preparation of the mailpiece 10. Any other information may be accessible by using the QR code 61, such as advertising and/or the like.

Referring now to FIG. 2, the rear side 12 of the mailpiece 10 is illustrated. The first separation line 20 may extend from the first end 15 to the second end 16. The first separation line 20 may provide the user with the ability to detach and/or separate the top panel 17 and the bottom panel 18. A peel strip 65 may extend from the first end 15 to the second end 16. Also, the peel strip 65 may extend from the first separation line 20 to the fold line 52. Thus, the peel strip 65 may be sized to cover the flap 55 on the back side 12 of the mailpiece 10. Also, the back side 12 of the mailpiece 10 may have an adhesive 66 in the area of the flap 55. The adhesive 66 may be, for example, a permanent and/or a semi-permanent adhesive. The peel strip 65 may be manufactured from a type of material that may be removably attachable via the adhesive 66, for example, a sheet of UV silicone. Of course, other materials known to one having ordinary skill in the art may also be used for the peel strip 65.

Referring now to FIG. 2, a back plan view of an embodiment of the mailpiece 10 is illustrated. The back side 12 of the mailpiece 10 may have information and/or instructions related to the sections on the front side 11 of the mailpiece 10. As shown in FIG. 2, the mailpiece 10 may have textual information 67 and/or graphical information 68 describing the components and/or sections of the mailpiece 10. The textual information 67 and/or the graphical information 68 may aid the user in understanding the use of the components and/or the sections in preparation of the mailpiece 10.

For example, a label information section 70 may provide information and/or instructions on how to use the mailpiece 10 and/or how to apply the label section 35 on the front side 11 of the mailpiece 10. In FIG. 2, the label information section 70 may have illustrations 69 of the label section 35 and/or the envelope 40 of the mailpiece 10. The label information section 70 may also have accompanying text 71 describing how to use the label section 35 and/or the envelope 40 of the mailpiece 10.

Further, the label information section 70 may provide information related to the special service indicator labels 36 and/or their uses. For example, the special service indicator labels may be used as internal tracking numbers by the user in a shipping log, a tracking log, a receipt book and/or any other record-keeping book and/or device and/or the like. Also, the label information section 70 may provide information related to the auxiliary label 37 and/or its uses. For example, the auxiliary label 37 may be used as an extra address label or in any other manner desired by the user.

Similarly, a receipt section information section 73 may be located on the back side 12 of the mailpiece 10 in a position corresponding to the location of the receipt section 22 on the front side 11 of the mailpiece 10. The receipt section information section 73 may provide information related to the receipt section 22 and/or its uses.

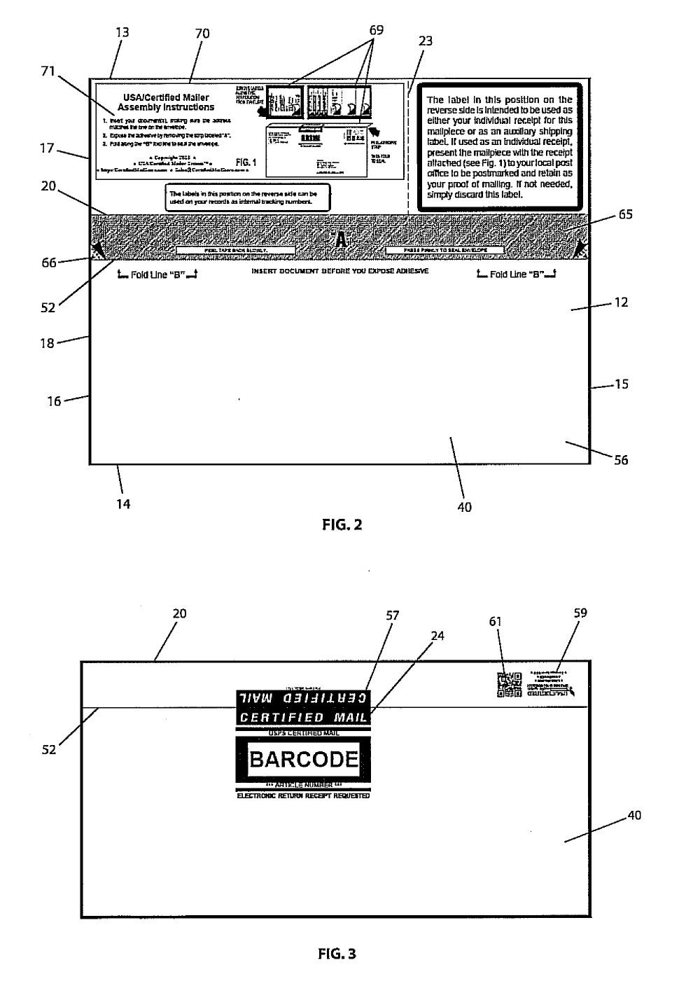

FIG. 3 illustrates a front plan view of the envelope 40 of the mailpiece 10. The label section 35 and/or the receipt section 22 may have been detached from the envelope 40 by tearing the top panel 17 from the bottom panel 18 via the first separation line 20.

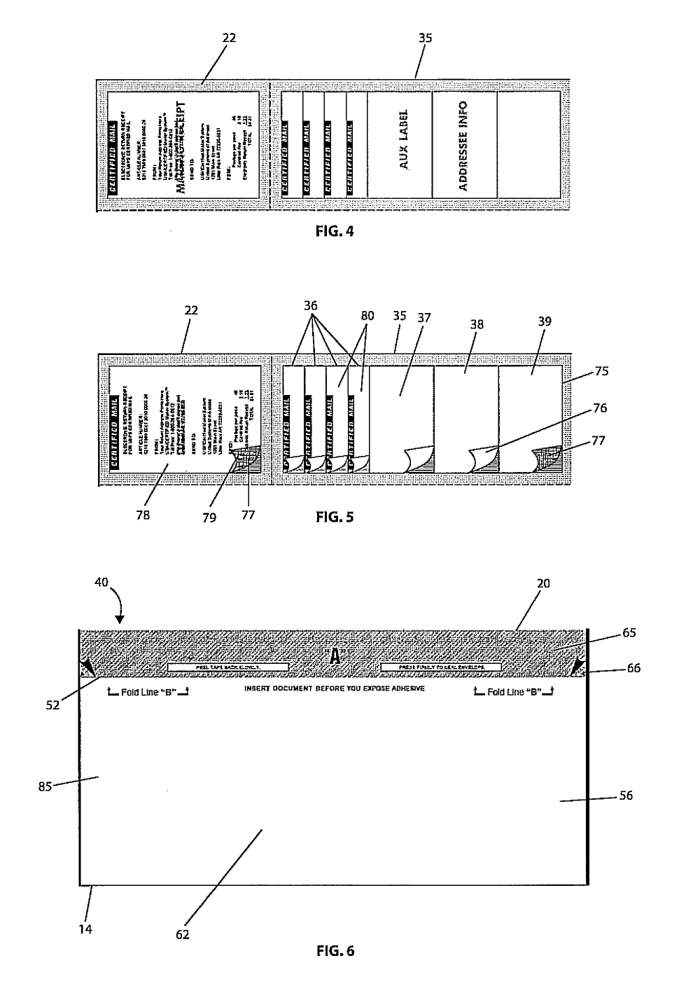

FIG. 4 illustrates a front plan view of the label section 35 of the mailpiece 10. The label section 35 may have been detached from the envelope 40 by tearing the top panel 17 from the bottom panel 18 via the first separation line 20. The label section 35 may also have been detached from the receipt section 22 via the second separation line 23.

FIG. 5 illustrates a rear plan view of the label section 35 and/or the receipt section 22 of the mailpiece 10. The label section 35 may be detached from the envelope 40 by tearing the top panel 17 from the bottom panel 18 via the first separation line 20. The label section 35 may also be detached from the receipt section 22 via the second separation line 23.

As shown in FIG. 5, the label section 35 and/or the receipt section 22 may be removably attached to the mailpiece 10 and/or to each other. The label section 35 may have a front side 75 that may be printed. The label section 35 may also have a back side 76 which may have an adhesive 77. The adhesive 77 may be a peel and stick type adhesive and may be provided to attach components of the label section 35 to the mailpiece 10 requiring special service mailing and/or to other items, as desired. For example, one or more of the special service indicator labels 36, the auxiliary label 37, the addressee information label 38 and/or the miscellaneous section label 39 may be removable adhesive labels with the adhesive 77 on the back side 76 of each respective label. For example, one or more of the special service indicator labels 36, the auxiliary label 37, the addressee information label 38 and/or the miscellaneous section label 39 may be attached via the adhesive 77 to a shipping log, a tracking log, a receipt book and/or any other record-keeping book and/or device and/or the like, as desired.

Further, in the embodiment shown, the special service indicator labels 36 may also have a section 80 for the article identification number 26. The special service indicator labels 36 may be used for records that the sender may maintain. For example, the special service indicator labels 36 may be adhesively backed for subsequent attachment to the receipt section 22 or other item requiring designation of the article identification number 26 for related purposes. For example, the special service indicator labels 36 may be used by a postal delivery employee on a USPS form PS 3849, a delivery notice, (not shown). Alternatively, the special service indicator labels 36 may be used for recordkeeping by the receiver. The special service indicator labels 36 may preferably be a peel and stick type label.

As shown in FIG. 5, the receipt section 22 may also have a front side 78 that may be printed. The receipt section 22 may also have a back side 79 which may have the adhesive 77. Thus, the receipt section 22 may be attached via the adhesive 77 to a shipping log, a tracking log, a receipt book and/or any other record-keeping book and/or device and/or the like, as desired.

The mailpiece 10 may be pre-printed. The front side 11 and/or the rear side 12 of the mailpiece 10 may be printed. The front side may be printed with corresponding relevant information, for example, the sender address 27, the recipient address 28, the special service indicator 24, the article ID number 26, the barcode 49, information on the receipt section 22, information on the label section 35, the postage 61, other address information and/or the like. Printing may be done using any one or more of various printing methods, such as, for example, duplex printing and/or simplex printing using a printer.

In an embodiment, as shown in FIG. 6, the mailpiece 10 may be provided with a blank space 62 on the rear side 12 of the bottom panel 18 for receiving a communication 82. As shown in FIG. 9, the communication 82 may be printed, typed and/or handwritten on the mailpiece 10 before assembling the mailpiece 10 for delivery by the special service. The mailpiece 10 may be configured to receive, for example, the communication 82 printed, typed and/or handwritten on the rear side 12 of the mailpiece 10. The communication 82 may be printed, typed and/or handwritten directly on the mailpiece 10. The communication 82 may be a message from the sender, an advertisement, marketing information, an illustration and/or the like. The communication 82 may be unique and/or individualized for the recipient on each mailpiece 10. The communication 82 may also be similar or identical on a plurality of mailpieces 10.

Referring now to FIGS. 3, 6, 7, 9 and 10, the envelope 40 of the mailpiece 10 requiring delivery by a special service is illustrated. When preparing the mailpiece 10 for mailing, the receipt section 22 and/or the label section 35 of the top panel 17 may be removed from the envelope 40 via the first separation line 20. The top panel 17 may be detachable and/or separated from the mailpiece 10 at the first separation line 20. The first separation line 20 may allow a user to remove the top panel 17 before assembling the mailpiece 10 for delivery by the special service. The mailpiece 10 may be thereby separated into the envelope 40 shown in FIG. 3 and the top panel 17 shown in FIG. 4.

After removal of the top panel 17 from the envelope 40, the flap 55 on the front side 41 of the envelope 40 may be folded along the fold line 52. The back side 56 of the envelope 40 may be located opposite to the front side 41 of the envelope 40. Thus, folding the mailpiece 10 along the fold line 52 may cause the flap 55 to come into contact with the back side 56 of the mailpiece 10. After folding the flap 55 along the fold line 52 of the envelope 40, the fold line 52 may be a top edge 81 of the envelope 40.

Referring to FIGS. 1-3, the special services designation section 44 may be printed on the front side 41 of the envelope 40. The special services designation section 44 may be associated with the special service that may be used with the mailpiece 10. The special services designation section 44 may be printed above and/or below the fold line 52 of the envelope 40 on the front side 11 of the mailpiece 10.

As shown in FIGS. 1-3, the special service indicator 24 of the special services designation section 44 may be printed below the fold line 52. However, the additional special service indicator 57 may be printed above the fold line 52. The additional special service indicator 57 may be essentially identical to the special service indicator 24 printed below the fold line 52. However, the additional special service indicator 57 above the fold line 52 may be rotated, for example, 180 degrees relative to the special service indicator 24 below the fold line 52. Thus, the additional special service indicator 57 printed above the fold line 52 of the envelope 40 may thereby be presented in an upright orientation to be readable when the mailpiece 10 may be folded along the fold line 52 and/or assembled for mailing as shown in FIG. 9.

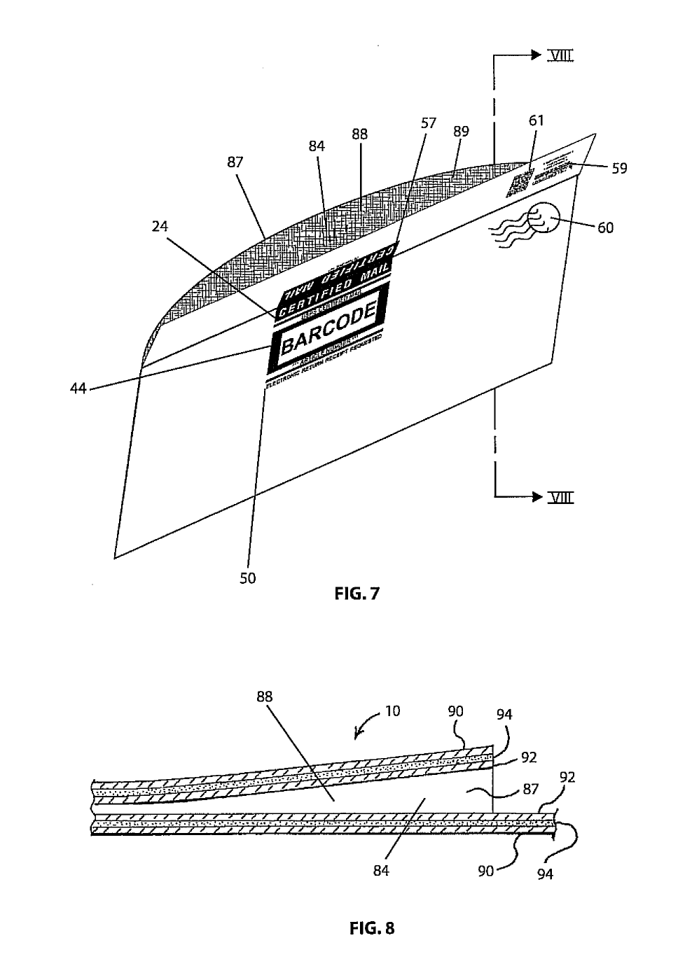

In an embodiment, as shown in FIG. 7, the mailpiece 10 may be provided with a pocket 84 for receiving an item (not shown) to be mailed using the mailpiece 10. The item may be a document, such as, for example, a single-paged and/or a multi-paged document, a bi-folded document, a tri-folded document, an unfolded document, a check, one or more tickets, a form, an envelope and/or the like. The pocket 84 may be sized to receive, for example, an envelope, such as, for example, a standard #9 envelope and/or the like with or without multiple pages and/or items enclosed therein. The mailpiece may be customized for use with various business or personal communications as needed. The present invention should not be deemed as limited to a specific embodiment of the item. It should be understood that the item may be any type of correspondence and/or item that may require mailing by the special service as known to one having ordinary skill in the art.

FIG. 7 illustrates an embodiment of the invention having the pocket 84 on the rear side 12 of the mailpiece 10. The pocket 84 may have a covering flap 85 affixed to the rear side 12 with an adhesive (not shown) at a perimeter of the covering flap 85. The perimeter of the covering flap 85 may have, for example, four edges wherein at least three edges may be affixed to the rear side 12 of the mailpiece 10. The pocket 84 may have an opening 87 for accessing the pocket 84 at the edge that may not be affixed to the mailpiece 10. The adhesive may be provided, for example, in a continuous pattern along the bottom end 14 of the bottom panel 18 and/or along the first end 15 and/or the second end 16 of the bottom panel 18. The adhesive may be, for example, a permanent adhesive and/or a semi-permanent adhesive. The adhesive may be any adhesive for providing a permanent seal and/or a semi-permanent seal between layers of paper as known to a person having ordinary skill in the art.

The continuous pattern of the adhesive 86 together with the permanent and/or semi-permanent nature of the adhesive 86 may prevent an unnoticed opening of the mailpiece 10 followed by a re-sealing of the mailpiece 10. Thus, the recipient may determine if the mailpiece 10 has been opened or tampered with during delivery via the special service.

Moreover, the user may print and/or may write the communication 82 on the covering flap 85 on the rear side 12 of the mailpiece 10 and/or on the covering flap 85 of the pocket 84. Further, the sender may print information, such as, for example, the return address, the postage, the mailing address and/or the like on the front side 11 of the mailpiece 10.

In an embodiment, as shown in FIG. 7, an interior 88 of the pocket 84 may be printed with a security pattern 89 which may be, for example, a solid color, indicia, a mark and/or the like that may increase the opacity of the pocket 84 and/or the mailpiece 10 and/or that may obscure a viewing of the item(s) within the interior 88 of the pocket 84 when the mailpiece 10 is assembled. The present invention should not be deemed as limited to a particular embodiment of the security pattern 89. The security pattern 89 may be any printing, indicia, mark and/or the like known to a person having ordinary skill in the art.

Thus, when the sender may be ready to send the mailpiece 10, the flap 55 on the front side 41 of the envelope 40 may be folded along the fold line 52 to thereby enclose the pocket 84 in the mailpiece 10 in an assembled state. The mailpiece 10 may be sealed at this position to obscure the item(s) in the pocket 84 and/or to secure the item(s) during mailing via the special service. In an embodiment, the mailpiece 10 may be sealed by removing the peel strip 65 on the rear side 12 of the mailpiece 10 to expose the adhesive 66 under the peel strip 65. The peel strip 65 may extend the length of the mailpiece 10 from the first end 15 to the second end 16. The peel strip 65 may extend from the fold line 52 to the first separation line 20. Thus, the peel strip 65 may be generally rectangular in shape. Thus, the peel strip 65 may be positioned in the same respective location on the rear side 12 of the mailpiece 10 as the flap 55 may be positioned on the front side 11 of the mailpiece 10.

FIG. 8 generally illustrates a cross-sectional view of the mailpiece 10. The mailpiece 10 may be constructed from a paper product, such as, for example, a laminated paper, a composite paper and/or the like as illustrated in FIG. 8. In a preferred embodiment, the mailpiece 10 may be constructed from a composite paper having a first paper layer 90 that may be laminated to a second paper layer 92 with a binding layer 94, such as, for example, an adhesive, a glue, an epoxy, a resin, a binding agent and/or the like. Using a composite paper may increase a durability of the mailpiece 10. Further, after the binding layer 94 may bond to the composite paper to form the sealed and/or assembled mailpiece 10, any tampering with the seal and/or any attempt to open the mailpiece 10 may result in fibers from the first paper layer 90 and/or the second paper layer 92 being torn from the binding layer 94. Such fiber tearing may be obvious to the recipient of the mailpiece 10 and/or may be an indication that the mailpiece 10 was tampered with during delivery by the special service.

FIGS. 9 and 10 illustrate the mailpiece 10 for delivery by the special service in an embodiment of the present invention. FIG. 9 illustrates a rear plan view of the mailpiece 10 in an assembled state. The flap 55 may have been folded on the fold line 52 of the envelope 40. The flap 55 may enclose the pocket 84 to secure the contents therein. As illustrated, the additional special service indicator 57 may be visible in an upright position so that the additional special service indicator 57 may be readable. Further, the information section 59 and/or the QR code 61 may be printed on the back side 56 of the envelope 40. Also, the communication 82 may also be printed on the back side 56 of the envelope 40.

FIG. 10 illustrates a front plan view of the mailpiece 10 in an assembled state. The special service indicator 24 on the special services designation section 44 may be printed on the front side 41 of the envelope 40. The front side 41 of the envelope 40 may also be printed with corresponding relevant information, for example, the sender address 27, the recipient address 28, the special service indicator 24, the article ID number 26, the barcode 49, information on the receipt section 22, information on the label section 35, the postage 61, other address information and/or the like. The envelope 40 may also have the electronic return receipt information section 50 on the front side 41 of the envelope 40 for use with the ERR service provided by the USPS. The electronic return receipt information section 50 may have the wording “ELECTRONIC RETURN RECEIPT REQUESTED.”

After delivery of the assembled mailpiece 10 via the special service, the recipient may open the mailpiece 10 as usual for any envelope. The recipient may bend, tear and/or remove a portion of the envelope 40. The recipient may slide, for example, a finger and/or a letter opener between the flap 55 and the back side 56 of the envelope 40 to break the seal of the adhesive 66. The recipient may review the communication 82 and/or the item(s) in the pocket 84. The recipient may review the communication 82 without opening the envelope 40 and/or the pocket 84. The expended mailpiece 10 may be kept, disposed of and/or recycled by the recipient after delivery via the special service.

As shown in FIG. 11, the mailpiece 10 may be prepared and/or processed in an automated manner using the computer system 300 having a mailing/tracking software application. An embodiment of the computer system 300 is illustrated in FIG. 11. The computer system 300 may have a computer 305 connected in a network 310. The network 310 may be any of a general local area network (“LAN”), a wireless local area network (“WLAN”), a wireless personal area network (“WPAN”) and/or the like. The network 310 may operate on a common wired Ethernet network or a Wi-Fi network wherein Wi-Fi is the brand name for products using IEEE 802.11 standards. The network 310 may be used for printing, transferring files and/or the like. Various components in the network 310 may be connected to operate as desired. The network 310 may be capable of accessing the Internet 330.

For example, the computer system 300 may have a user interface 315 for inputting and/or viewing data related to the printing, preparation and/or delivery status of the mailpiece 10. The user interface 315 may be a terminal, a keyboard, a handheld device and/or the like. Any known user interface may be used and may be considered to be within the scope of the invention. A printer 320 may also be connected and/or networked to the computer system 300 in the network 310. The connection of the printer 320 to the computer system 300 in the network 310 may use wires, cables, fiber optics and/or the like. Alternatively, wireless, Bluetooth and/or Wi-Fi interfaces may be used as a replacement for cabling. In particular, Bluetooth may be used for portable equipment and/or its applications. Also, Bluetooth may be a replacement for cabling in a variety of personally carried applications in any setting and also may work for fixed location applications.

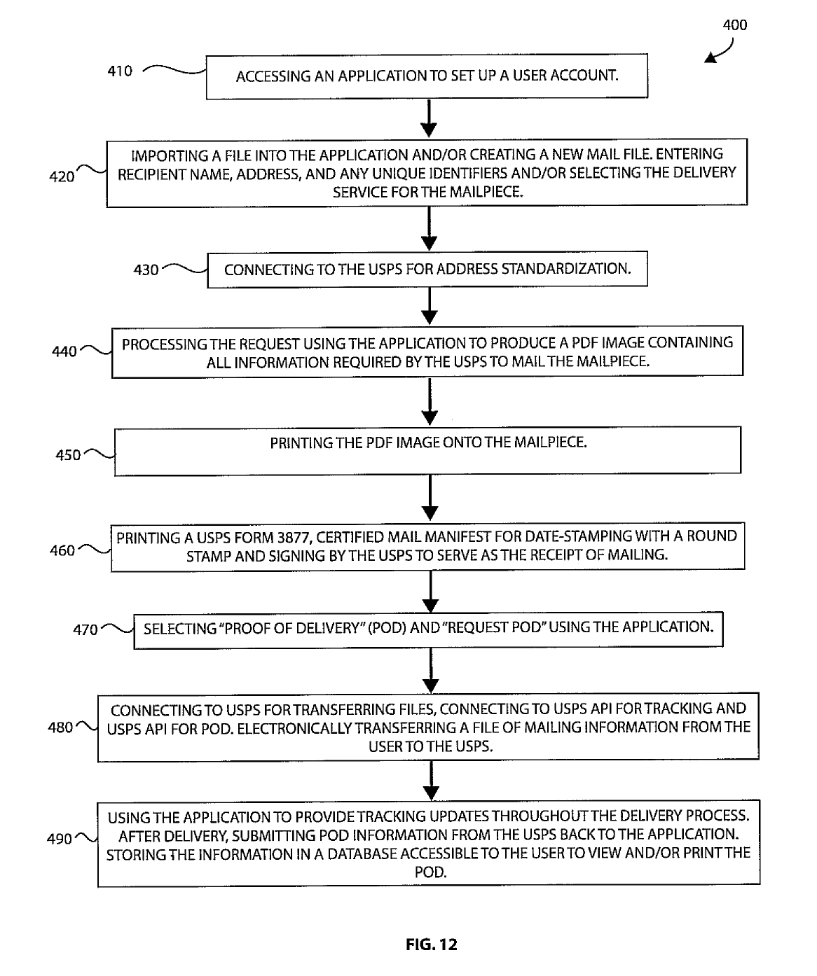

In an embodiment shown in FIG. 12, a method 400 for using the unitary special service delivery form mailpiece 10 for delivery by a special service having an electronic return receipt may be provided. The user may utilize the computer system 300 shown in FIG. 11 for performing the method 400 shown in FIG. 12. The method 400 may allow the user to input and/or view data related to printing, preparation and/or delivery status of the mailpiece 10. The user may obtain a supply of the mailpieces 10. Also, the user may obtain initial logon information for using a software application.

In step 410, the user may log on to a website, for example, USAMailer.com operated by the assignee of the present application, to access the application. The user may log on using the user interface 315 of the computer system 300. The user may have the option within the application to set up multiple accounts and/or mailings for different users.

In step 420 of the method 400, the user may either import a file into the application and/or may create a new mail file. In step 420, the user may enter recipient name, address, and/or any unique identifiers. In step 420, the user may also select the manner for delivery of the mailpiece 10 by the USPS. In the illustrated embodiment of the mailpiece 10, the user may select First Class, Certified, and/or Electronic Return Receipt (ERR).

The method 400 may also have a step 430 in which the application may utilize an Application Programming Interface (API) to connect to the USPS for address standardization. In step 440 of the method 400, the user may process the request using the application. The application may produce a pdf image. The pdf image may contain all information required by the USPS to mail the mailpiece 10, as desired.

In step 450, the user may print the pdf image using the printer 320 of the computer system 300 onto the mailpiece 10. The user may remove certain components of the mailpiece 10, as required and/or desired. The addressee section 42 may be pre-printed with the address of the intended recipient of the mailpiece 10. The sender section 43 of the mailpiece 10 may be pre-printed with the address of the sender of the mailpiece 10. Further, the special services designation section 44 having information indicative of the special service may be printed on the mailpiece 10.

In step 460, the user may use the application to print a USPS Form 3877, which may be a Certified Mail Manifest. The Form PS-3877 may be presented if three or more Certified Mail letters are mailed at a USPS Post Office. The computer-generated manifest may contain postal information, rates, fees and/or article numbers approved by the postmaster. The user may present three or more letters and have the manifest date-stamped with a round stamp and/or signed by the USPS acceptance person. The stamped Form PS-3877 may serve as a receipt or proof that the letter was accepted into the USPS mail stream. The Form PS-3877 may thus provide the receipt of mailing.

In step 470, the user may also select “Proof of Delivery” (POD) using the application and then “Request POD.” In step 480 of the method 400, the application may connect to USPS for transferring files, connecting to USPS API for Tracking and/or USPS API for POD. A file of mailing information and/or the information submitted by the user may be electronically transferred to the USPS utilizing the application.

In step 490 of the method, the application may provide tracking updates throughout the delivery process. After delivery, the USPS may submit POD information back to the application. The application may store the information in a database that may be accessible to the user. The user may log on to the application on the website USAMailer.com to view and/or print the POD.

The mailpiece 10 may be manufactured in numerous embodiments. The various embodiments of the mailpiece 10 may have additional components which may provide enhanced functionality of the mailpiece 10.

Other variations and/or configurations which are known to one having ordinary skill in the art are possible and are deemed to be within the scope of this disclosure. The materials used for the components of the mailpiece 10 may be selected from any suitable material to perform the desired function for operation of the mailpiece 10. The materials must also be capable of withstanding environmental conditions that may be encountered. Considerations of performance and/or reliability are also important in the selection of the material. Other materials which are known to one having ordinary skill in the art may be selected and are deemed to be within the scope of this disclosure.

Moreover, the present invention may not be limited to the specific arrangement of the components illustrated in the figures. It should be understood that various changes and/or modifications to the presently preferred embodiments described herein will be apparent to those having ordinary skill in the art. Such changes and/or modifications may be made without departing from the spirit and/or scope of the present invention and without diminishing its attendant advantages. It is, therefore, intended that such changes and/or modifications be covered by the appended claims.

We claim:

1. A unitary special service form mailpiece for delivery via a special service, the mailpiece comprising:
a generally rectangular sheet having a width defined between a front side and a rear side wherein the rear side is positioned opposite to the front side wherein the sheet has a height defined between a top end and a bottom end wherein the bottom end is positioned opposite to the top end wherein the sheet has a length defined between a first end and a second end wherein the second end is positioned opposite to the first end wherein the sheet is divided into a top panel and a bottom panel wherein the top panel is positioned adjacent to the bottom panel wherein the top panel and the bottom panel are separated by a separation line that extends between the first end of the sheet and the second end of the sheet wherein the top panel is removable from the bottom panel at the separation line and further wherein the bottom panel has a fold line that extends between the first end of the sheet and the second end of the sheet;
a flap defined between the separation line and the fold line wherein the flap extends between the first end of the sheet and the second end of the sheet wherein the flap has a front side and a rear side wherein the rear side is positioned opposite to the front side;
a pocket in the bottom panel wherein the pocket extends between the first end and the second end wherein the pocket extends between the bottom end and the fold line and further wherein the pocket has an opening adjacent to the fold line;
an adhesive on the rear side of the flap wherein the adhesive adheres the flap to the rear side of the bottom panel when the flap is folded along the fold line and further wherein the flap thereby seals the opening of the pocket;
a first section on the front side of the mailpiece wherein the first section has information related to an electronic return receipt service associated with the mailpiece wherein the first section has a machine-readable code section having machine-readable information associated with the mailpiece; and
a second section on the front side of the mailpiece wherein the second section has information indicative of the special service for delivery of the mailpiece.

2. The mailpiece of claim 1 wherein the separation line is a linear perforation.

3. The mailpiece of claim 1 further comprising:
an auxiliary special services designator section on the top panel wherein the auxiliary special services designator section has information indicative of the special service and further wherein the auxiliary special services designator section is separable from the bottom panel via the separation line.

4. The mailpiece of claim 1 further comprising:
a receipt on the top panel wherein the receipt has information associated with the delivery of the mailpiece by the special service and further wherein the receipt is separable from the bottom panel via the separation line.

5. The mailpiece of claim 1 further comprising:
an auxiliary information section printed on the sheet wherein the auxiliary information section has information unrelated to the mailpiece.

6. The mailpiece of claim 1 further comprising:
a Quick Response (QR) code printed on the sheet wherein the QR code has machine-readable information.

7. The mailpiece of claim 1 further comprising:
instructions for use of the mailpiece printed on the sheet.

8. The mailpiece of claim 1 further comprising:
a message section located on the rear side of the mailpiece wherein a communication is printed on the message section.

9. The mailpiece of claim 1 wherein the sheet is a laminated paper product.

10. The mailpiece of claim 1 further comprising:
an adhesive label on the top panel wherein the adhesive label is removable from the top panel.

11. A method for preparing a mailpiece for delivery by a special service, the method comprising the steps of:
providing a unitary special services form mailpiece wherein the mailpiece has a pocket;
printing information on the mailpiece wherein the information is necessary to comply with requirements for the delivery of the mailpiece by the special service;
printing information on the mailpiece wherein the information is related to delivery of the mailpiece; and
printing information on the mailpiece wherein the information is necessary to comply with requirements for electronic return receipt of the mailpiece wherein the information has a machine-readable code section having machine-readable information concerning electronic return receipt of the mailpiece associated with the mailpiece.

12. The method of claim 11 further comprising:
inserting an item into the pocket; and
sealing the pocket to enclose the item within the pocket before mailing the mailpiece.

13. The method of claim 11 further comprising:
printing a label on the mailpiece wherein the label has information related to the special service of the mailpiece; and
removing the label from the mailpiece before mailing the mailpiece.

14. The method of claim 11 further comprising:
printing a receipt on the mailpiece wherein the receipt has information related to the delivery of the mailpiece; and
removing the receipt from the mailpiece before mailing the mailpiece.

15. The method of claim 11 further comprising the step of:
printing auxiliary information on the sheet wherein the auxiliary information has information unrelated to the mailpiece.

16. The method of claim 11 further comprising the step of:
printing a communication on the rear side of the mailpiece.

17. A method for preparing a mailpiece for delivery by a special service using a mailing application on a computer system, the method comprising the steps of:
accessing the mailing application on the computer system;
creating a mail file using the mailing application wherein the mail file has information associated with delivery and the special service for the mailpiece;
processing the mail file information using the mailing application to produce an image containing information required by an entity to deliver the mailpiece by the special service; and
printing the image onto the mailpiece.

18. The method of claim 17 further comprising the steps of:
transferring the mail file to the entity using the mailing application; and
receiving tracking information from the entity.

19. The method of claim 17 further comprising the step of:
receiving electronic return receipt information from the entity.

20. The method of claim 17 further comprising the step of:
storing electronic return receipt information from the entity in a database using the mailing application.
